(19) United States
(12) Patent Application Publication
(10) Pub. No.: US 2010/0003508 A1
(43) Pub. Date: Jan. 7, 2010

(54) OPTICAL ARTICLE WITH ANTISTATIC AND ANTIABRASIVE PROPERTIES, AND METHOD FOR PRODUCING SAME

(75) Inventors: Frederic Arrouy, Charenton Le Pont (FR); Claudine Biver, Charenton Le Pont (FR); Gregory Hervieu, Charenton Le Pont (FR)

Correspondence Address: FULBRIGHT & JAWORSKI L.L.P., 600 CONGRESS AVE., SUITE 2400, AUSTIN, TX, 78701, US

(73) Assignee: Essilor International (Compagnie Generale d'Optique), Charenton Le Pont (FR)

(21) Appl. No.: 12/375,467

(22) PCT Filed: Jul. 31, 2007
(86) PCT No.: PCT/FR2007/051761

§ 371 Date: Jan. 28, 2009

(30) Foreign Application Priority Data
Jul. 31, 2006 (FR) 0653225

(51) Int. Cl. B32B 5/00; B32B 27/40; B05D 5/06; B05D 3/04; B32B 27/08; B32B 27/30; B05D 3/14; B05D 3/06

(52) U.S. Cl. 428/336; 428/423.1; 427/162; 427/535; 428/424.2; 428/425.5; 428/424.4; 427/540; 427/553

(57) ABSTRACT

The present invention relates to an optical article comprising a substrate, and, from the substrate upward:
an organic antistatic coating comprising at least one conductive polymer,
an adhesive and/or impact-resistant primer coating deposited onto said antistatic coating, and
an abrasion-resistant and/or scratch-resistant coating deposited onto said adhesive and/or impact-resistant primer coating.

The optical article has very short static charge dissipation times and its antistatic properties are stable over time.

The present invention generally relates to an optical article, in particular to an ophthalmic lens, having both antistatic (AS), abrasion-resistant and/or scratch-resistant properties and preferably impact-resistant properties, as well as to a method for producing such an optical article.

It is known to superficially protect ophthalmic glasses, whether they are mineral or organic, by means of hard coatings (abrasion-resistant and/or scratch-resistant coatings) which are typically based on polysiloxane. It is also known to treat ophthalmic lenses so as to prevent any stray or unwanted reflected light from appearing, what would disturb the lens wearer and the persons he or she is talking to. The lens is then provided with a mono- or a multilayered antireflective coating, generally made of a mineral material.

When the lens comprises within its structure a hard abrasion-resistant coating, the antireflective coating is generally deposited onto the abrasion-resistant layer surface. Such a stack reduces the impact strength, by rigidifying the system then becoming brittle. This problem is well known in the industry of ophthalmic lenses made of organic glass.

To counteract such a drawback, it has been suggested to provide an impact-resistant primer layer between the lens in organic glass and the abrasion-resistant hard coating.

It is also well known that optical articles made of substantially insulating materials tend to have their surface becoming easily charged with static electricity, particularly when cleaned under dry conditions by rubbing their surface with a wiping cloth, a piece of synthetic foam or of polyester (triboelectricity). Charges present on the surface thereof do create an electrostatic field able of attracting and retaining objects with a very low weight standing in the vicinity (a few centimetres away therefrom), generally very small sized-particles such as dust, and for all the time the charge remains effective on the article.

In order to reduce or to inhibit the particle attraction, it is necessary to reduce the electrostatic field intensity, that is to say to reduce the number of static charges present on the article surface. This may be done by making the charges mobile, for example by inserting a layer of a material inducing a strong mobility of the “charge carriers”. The materials inducing the strongest mobility are the so called conducting materials. Thus, a high-conductivity material makes it possible to more rapidly dissipate the charges.

The state of the art reveals that an optical article may be given antistatic properties by incorporating into the surface thereof, in the functional coating stack, at least one electroconductive layer, which is called “antistatic layer.” Such an antistatic layer may form the outer layer of the functional coating stack, or an intermediate layer (inner layer), or may be directly deposited onto the optical article substrate. Incorporating such a layer into a stack provides the article with AS properties, even if the AS coating is inserted between two non antistatic coatings or substrates.

As used herein, “antistatic” does mean the ability not to retain and/or develop a substantial electrostatic charge. An article is generally considered as having acceptable antistatic properties, when neither attracting nor retaining dust and small particles after one surface thereof has been rubbed using a suitable wiping cloth. It is able to rapidly dissipate the accumulated electrostatic charges.

Various methods for quantifying the antistatic properties of a material may be used.

The antistatic property of a material is frequently associated with the static potential of the same. When the static potential of the material (measured when the article has not been charged) is of 0 KV+/−0.1 KV (absolute value), the material is considered as being antistatic, on the other hand when its static potential is different from 0 KV+/−0.1 KV (absolute value), the material is considered as being static.

The ability for a glass to drain a static charge off that was obtained by rubbing with a cloth or by any other means suitable for creating an electrostatic charge (a corona charge for instance) may be quantified by measuring the dissipation time of said charge. Thus, antistatic glasses do possess a discharge time which is of about a hundred milliseconds, whereas it is of dozens of seconds for a static glass, sometimes even of a few minutes. A static glass which has just been wiped may therefore attract surrounding dust during all the time required for the charge to be drained off.

The known antistatic coatings comprise at least one antistatic agent, which is generally a metal oxide (semi)conductor optionally doped, such as tin-doped indium oxide (ITO), antimony-doped tin oxide, vanadium pentoxide or a conductive polymer with a conjugated structure.

The patents EP 0 834 092 and U.S. Pat. No. 6,852,406 disclose optical articles, in particular ophthalmic lenses, provided with a mineral antireflective stack comprising a transparent, mineral antistatic layer deposited under vacuum, having an indium tin oxide (ITO) or a tin oxide base. Such a production is quite restrictive as it does not allow providing an antistatic optical article without any antireflective coating.

It is more advantageous to provide optical articles wherein the antistatic layer is independent from the antireflective stack. There are a number of patents or patent applications which describe articles provided with a conductive polymer-based antistatic layer directly deposited onto the article substrate.

The US patent application No 2004/0,229,059 describes an optical article comprising a conductive polymer-based antistatic coating that is ≧2 nm thick and is deposited onto a polyethylene terephthalate substrate (PET) or a polyester-based polarizing film, and is coated with a polymer (polyacrylate, polyolefin or polycarbonate) overlayer. The substrate may optionally be coated with a primer layer prior to depositing the AS coating. Although they have a high surface resistivity (higher than or equal to 10¹²Ω/), optical articles described in this document yet are said to have antistatic properties, with discharge times of about 0.01 s.

The US patent application No 2004/0,209,007 describes an optical film, to be used in liquid crystal displays, comprising a substrate made of a polymer material coated with a 10-200 nm-thick antistatic layer based on a water-soluble or water-dispersible conductive polymer, said layer being in turn coated with an acrylic, silane or polyurethane contact adhesive layer (PSA), thereafter with a top layer.

The US patent application No 2002/0,114,960 describes an optical article comprising a stack composed of an organic or mineral glass substrate, a conductive layer based on a conductive polymer and an abrasion-resistant coating of the organosil(ox)ane type. Optionally, said conductive layer may be deposited onto a substrate coated with an adhesive layer of the aminosilane type.

The U.S. Pat. No. 6,096,491 discloses a cinematographic film comprising a polymer substrate successively coated with an electroconductive layer comprising a conductive polymer and with an abrasion-resistant, protective layer based on a polyurethane binder which is devoid of any crosslinking agent. The abrasion-resistant, protective layer is characterized by a Young's modulus as measured at 2% elongation of at least 50.10³ Psi (345 MPa) and by an elongation at break of at least 50%. Optionally, the conductive layer is deposited onto a substrate coated with an adhesion primer of the organic polymer type.

The U.S. Pat. No. 6,190,846 provides an alternative of the hereabove photographic film, wherein the polyurethane binder is integrated to the electroconductive layer comprising a conductive polymer and optionally a crosslinking agent, thus providing an abrasion-resistant and/or a scratch-resistant electroconductive layer. The European patent No 1 081 548 does use a similar approach and describes films comprising an abrasion-resistant, electroconductive layer, which may be the outer layer of the stack or be protected with a cellulose acetate overlayer.

The European patent No 1 521 103 describes how to prepare a plasma screen front plate comprising a polymer substrate having deposited thereon the following coatings: an abrasion-resistant coating (hard coat), a 5-300 nm-thick antistatic coating based on a conductive polymer and an antireflective coating, wherein the antistatic coating may be deposited either onto the substrate or onto the hard coat, or be integrated within the antireflective coating.

There is nothing about the impact strength in any of the hereabove mentioned documents.

Therefore, it is an object of the present invention to provide new optical articles, in particular ophthalmic glasses for spectacles, comprising a substrate made of mineral or organic glass, having both antistatic and abrasion-resistant and/or scratch-resistant properties and preferably impact-resistant properties, while preserving outstanding properties in terms of transparency and of adhesion of the various coating layers to each other, in the absence of any optical defect. The amount of dust deposited on the surface of such an article because of the static electricity produced by rubbing (triboelectricity) upon wiping would thus be significantly reduced and so such an article would therefore appear to be “cleaner” after wiping.

It is another object of the present invention to provide an optical article whose antistatic properties are stable over time.

It is a further object of the present invention to provide a method for making an article such as hereabove defined, that can be easily included within the traditional method for making said articles while improving the productivity thereof.

The objectives as defined herein are aimed at according to the present invention with an optical article comprising a substrate and, from the substrate upward:
an organic antistatic coating comprising at least one conductive polymer,
an adhesive and/or impact-resistant primer coating deposited onto said antistatic coating, and
an abrasion-resistant and/or scratch-resistant coating deposited onto said adhesive and/or impact-resistant primer coating.

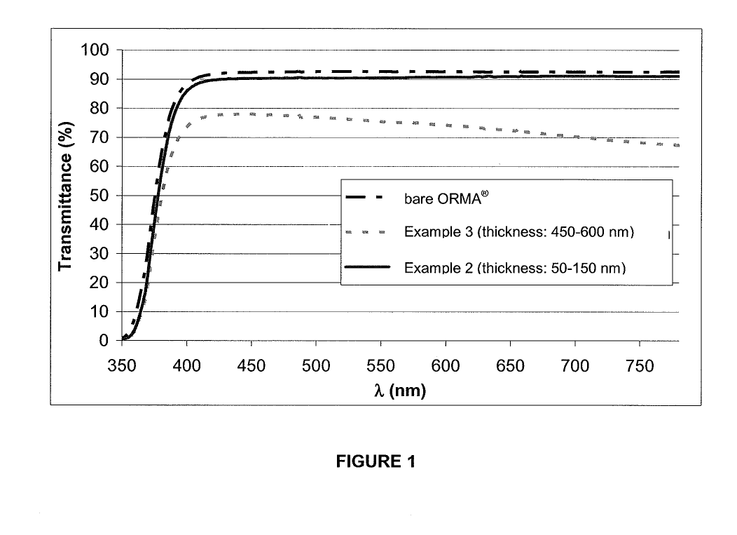

The present invention will be described in more detail by referring to the appended drawings, wherein FIG. 1 represents the light transmittance curve for ophthalmic lenses coated, or not, with an antistatic coating of the invention.

In the present application, “antistatic coating” and “electroconductive coating” have the same meaning and will be used indiscriminately.

The present invention does imply the insertion of a conductive polymer thin layer between the optical article substrate and the primer coating imparting the adhesion and/or the impact resistance properties, what offers two advantages as compared to a stack wherein the conductive organic layer would be positioned at the antireflective coating level. The fact that both the conductive layer used and the adhesive and/or impact-resistant primer coating are organic coatings does ensure a better affinity and thus a better adhesion. On the other hand, the methods used for depositing the conductive polymer layer are the same as for depositing the adhesive and/or impact-resistant primer coating and the abrasion-resistant coating (generally by dip-coating or spin-coating), while the antireflective coatings are generally deposited using a vacuum treatment.

According to the invention, the optical article comprises a substrate, preferably a transparent substrate, made of organic or mineral glass, having main front and rear faces, at least one of said main faces of which comprises a stack composed of an antistatic coating/an adhesive and/or impact-resistant primer coating/an abrasion-resistant and/or scratch-resistant coating, said coatings being deposited onto the substrate in the given order.

Although the article of the invention may be any optical article, such as a screen or a mirror, this is preferably an optical lens, more preferably an ophthalmic lens, or an optical or ophthalmic lens blank.

The antistatic coating of the invention may be formed onto at least one of the main faces of a bare substrate, that is to say a non coated substrate, or onto at least one of the main faces of an already coated substrate having one or more functional coating(s).

Preferably, it is deposited onto a bare substrate, that is to say a non coated substrate.

The optical article substrate is preferably made of organic glass, for example of a thermoplastic or thermosetting plastic material. Examples of thermoplastic materials to be suitably used for the substrates include (meth)acrylic (co)polymers, in particular poly(methyl methacrylate) (PMMA), thio(meth)acrylic (co)polymers, polyvinyl butyral (PVB), polycarbonates (PC), polyurethanes (PU), poly(thiourethanes), polyol allylcarbonate (co)polymers, thermoplastic ethylene/vinyl acetate copolymers, polyesters such as poly(ethylene terephthalate) (PET) or poly(butylene terephthalate) (PBT), polyepisulfides, polyepoxides, polycarbonate/polyester copolymers, cycloolefin copolymers such as ethylene/norbornene or ethylene/cyclopentadiene copolymers, and combinations thereof.

As used herein, a (co)polymer is intended to mean a copolymer or a polymer. A (meth)acrylate is intended to mean an acrylate or a methacrylate.

The preferred substrates according to the invention include substrates obtained by polymerizing alkyl(meth)acrylates, in particular C₁-C₄ alkyl(meth)acrylates, such as methyl (meth)acrylate and ethyl(meth)acrylate, polyethoxylated aromatic (meth)acrylates such as polyethoxylated bisphenol di(meth)acrylates, allyl derivatives such as aliphatic or aromatic, linear or branched polyol allylcarbonates, thio(meth)acrylates, episulfides and polythiol/polyisocyanate precursor mixtures (for preparing polythiourethanes).

As used herein, a polycarbonate (PC) is intended to mean either a homopolycarbonate, a copolycarbonate or a block copolycarbonate. Polycarbonates are commercially available, for example from the GENERAL ELECTRIC COMPANY under the trade name LEXAN®, from the TEIJIN company under the trade name PANLITE®, from the BAYER company under the trade name BAYBLEND®, from the MOBAY CHEMICHAL Corp. under the trade name MAKROLON® and from the DOW CHEMICAL Co. under the trade name CALIBRE®.

Suitable examples of polyol allylcarbonate (co)polymers include (co)polymers of ethyleneglycol bis(allylcarbonate), of diethyleneglycol bis(2-methyl allylcarbonate), of diethyleneglycol bis(allylcarbonate), of ethyleneglycol bis(2-chloro allylcarbonate), of triethyleneglycol bis(allylcarbonate), of 1,3-propanediol bis(allylcarbonate), of propyleneglycol bis(2-ethyl allylcarbonate), of 1,3-butenediol bis(allylcarbonate), of 1,4-butenediol bis(2-bromo allylcarbonate), of dipropyleneglycol bis(allylcarbonate), of trimethyleneglycol bis(2-ethyl allylcarbonate), of pentamethyleneglycol bis(allylcarbonate), of isopropylene bisphenol A bis(allylcarbonate).

As particularly recommended substrates may be mentioned the substrates obtained by (co)polymerizing diethyleneglycol bis(allylcarbonate), marketed, for example, under the trade name CR-39® by the PPG Industries company (ORMA® lenses from ESSILOR).

Particularly recommended substrates also include the substrates obtained by polymerizing thio(meth)acrylic monomers, such as those described in the French patent application No 2 734 827.

Of course the substrates may be obtained by polymerizing mixtures of the hereabove mentioned monomers or may also comprise mixtures of those polymers and (co)polymers.

The substrates may optionally be colored, in particular by dipping into coloring baths.

In the present invention, the antistatic coating may be applied onto the front face and/or the rear face of the substrate. It is preferably applied onto both front and rear faces of the substrate.

As used herein, the rear face of the substrate is intended to mean the face which, when using the article, is the nearest from the wearer's eye. On the contrary, the front face of the substrate is intended to mean the face which, when using the article, is the most distant from the wearer's eye.

Prior to depositing the antistatic coating onto the substrate, it is usual for the surface of said substrate to be submitted to a chemical or physical activating preliminary treatment intended to increase the adhesion of the AS coating, which is generally performed under vacuum, such as a bombardment with energetic species, for example with an ion beam (“Ion Pre-Cleaning” or “IPC”) or with an electron beam, a corona discharge treatment, an electric discharge treatment in a low pressure gas, an ultraviolet treatment, optionally at a low pressure, a plasma treatment under vacuum, an acid or basic treatment and/or a solvent-based treatment (water or any organic solvent), or the deposition of an adhesion-promoting agent layer. Many of these treatments may be combined, as for example a basic treatment and/or a solvent-based treatment may be combined with an ultraviolet treatment or with the deposition of an adhesion-promoting agent layer, or may be combined with an ultraviolet treatment followed with the deposition of an adhesion-promoting agent layer.

These surface preparation steps are particularly interesting when the substrate is made of organic glass. The preliminary treatment step is preferably a basic treatment, a treatment with solvents, an ultraviolet treatment, a corona or plasma treatment, a deposition treatment of an adhesion-promoting agent layer comprising preferably at least one aminosilane, or a combination of these treatments.

A layer of adhesion-promoting agent may be deposited by any suitable means, preferably by dip-coating or spin-coating using a liquid composition. It may comprise polyester-, polyurethane-, polyamide-, or polycarbonate-type polymers or copolymers, or polymers or copolymers based on acrylate or methacrylate monomers such as glycidyl acrylate, or on butadiene, vinyl halide or maleic anhydride monomers, or at least one silane or siloxane, preferably one aminosilane, or mixtures thereof.

The aminosilane type adhesion-promoting agent, preferably hydrolyzed, is an organosilane compound comprising at least one amine group, preferably NH or NH₂, which is able of interacting with the substrate and/or the AS coating material. The aminosilane may of course comprise other functional groups.

Preferably, the adhesion-promoting agent is an alkoxy silane bearing at least one amine group, more preferably a trialkoxysilane bearing at least one amine group. Suitable examples of aminosilanes include primary aminoalkyl silanes, secondary aminoalkyl silanes and bis-silylalkyl amines, and in particular 3-aminopropyl trimethoxysilane, 3-aminopropyl triethoxysilane, bis-trimethoxysilyl propylamine, N-β-(aminoethyl)-γ-aminopropyl trimethoxysilane (H₂NCH₂CH₂NHCH₂CH₂CH₂Si(OCH₃)₃), and the triaminofunctional H₂NCH₂CH₂NHCH₂CH₂NHCH₂CH₂CH₂Si(OCH₃)₃ compound, which are all commercially available. Of course, ethoxy analogues of such silanes may also be used.

The amount of adhesion-promoting agent to be used in the composition for depositing a layer of adhesion-promoting agent may be easily determined by the man skilled in the art having a minimum routine experience.

The AS coating of the invention is an organic coating comprising, as an antistatic agent, at least one conductive polymer. Amongst those, conductive polymers leading to thin transparent layers are preferred in the context of the invention. The AS coating of the invention is coated with at least two layers, and is thus protected against external mechanical or chemical damages (abrasion, scratches, oxidation, chemical contamination, etc.).

Suitable examples of transparent, conductive polymers include polyanilines, described for example in the U.S. Pat. Nos. 5,716,550 and 5,093,439, polypyrroles, described for example in the U.S. Pat. Nos. 5,665,498 and 5,674,654, polythiophenes, described for example in the U.S. Pat. Nos. 5,575,898, 5,403,467 and 5,300,575, polyethylene imines, polyselenophenes, allylamine-based compounds, and derivatives of those polymers. They may be used in combinations.

Such conductive polymers are generally used in a cationic form (polyaniline, polypyrrole, polythiophene cation, etc.) in combination with one or more polyanion(s). Polyanions may be selected, without limitation, from polymer carboxylic or sulfonic acid anions (polyacids) and mixtures thereof. Suitable examples thereof include polystyrene sulfonate, polyvinyl sulfonate, polyacrylate, polymethacrylate, polymaleate anions, as well as anions of copolymers obtained by copolymerizing at least one acid monomer such as acrylic, methacrylic, maleic, styrene sulfonic, or vinyl sulfonic acid, with at least one other acid or non acid monomer. Said non acid monomers do include styrene or acrylic esters. Polystyrene sulfonate is the preferred polyanion.

The number average molecular weight of the polyanion polyacid precursors does typically range from 1000 to 2.10⁶ g/mol, preferably from 2000 to 500000.

Polyacids may be prepared by known methods or are commercially available, optionally in the form of metal salts.

Preferred conductive polymers are polystyrene sulfonate polypyrroles, in particular 3,4-dialkoxy substituted, polypyrrole derivatives, and polystyrene sulfonate polythiophenes, in particular 3,4-dialkoxy substituted, polythiophene derivatives, and mixtures thereof. Poly(3,4-ethylenedioxythiophene)-poly(styrene sulfonate) and poly(3,4-ethylenedioxypyrrole)-poly(styrene sulfonate) have to be mentioned as specific examples of preferred conductive polymers.

Preferably, polystyrene sulfonate polythiophenes have a number average molecular weight, for the polythiophene part, ranging from 1000 to 2500 g/mol, and for the polystyrene sulfonate part, ranging from 100000 to 500000 g/mol, typically of 400000 g/mol.

Conductive polymers are commercially available or may be prepared according to known methods. A polystyrene sulfonate polypyrrole, for example, may be synthesized by an oxidative polymerization of pyrrole in an aqueous solution in the presence of poly(styrene sulfonic) acid and ammonium persulfate as an oxidizing agent.

The organic AS coating may be formed onto the optical article surface by any suitable means, in particular by means of a liquid or gas phase deposition, or by lamination.

In particular, the organic AS coating may be transferred onto the optical article surface from a film comprising on one of the faces thereof a conductive polymer coating.

The adhesion is ensured using a pressure-sensitive adhesive (PSA) that has been beforehand deposited onto the optical article surface, or an ultraviolet-curable or heat-curable adhesive composition that has also been beforehand deposited onto the optical article surface.

The film is then moved, with its face bearing the organic AS coating facing the optical article surface.

Upon contacting the antistatic coating with the adhesive composition, a pressure is applied on the external face of the film, which then conforms to the optical article surface.

A film that may be typically used is a PET film from the Agfa company, that is around 60 micrometers thick and onto which a conductive polythiophene coating has been deposited.

Preferably, the organic AS coating is wet deposited, in particular by depositing a liquid antistatic coating composition, comprising at least one conductive polymer, in a sufficient amount to provide in particular at least one main surface of an optical article, preferably the two main surfaces thereof, with the desired antistatic properties. Applying such a composition may be performed, without limitation, by spin-coating, dip-coating, brush or roll application, spray coating. Spin-coating or dip-coating are preferred.

Although the conductive polymer content in the coating composition is not particularly limited, it does preferably range from 0.1 to 30% by weight, more preferably from 0.2 to 5%. Beyond 30% by weight, the composition is generally excessively viscous, whereas below 0.1%, the composition is excessively diluted and the solvent flash-off time may become too long.

The antistatic coating composition may be a solution or a dispersion, both words being used indiscriminately herein. Both of them are intended to mean a macroscopically (visually) generally uniform mixture of components and do not refer to a particular solubility or particle size state of the various components.

The antistatic coating composition preferably comprises a dispersion (or a solution) of at least one conductive polymer in an aqueous or organic solvent, or in a mixture of these solvents, and optionally one or more binder(s). The antistatic coating composition is preferably a conductive polymer aqueous dispersion.

Conductive polymers may be substituted with various functional groups, especially with hydrophilic groups, preferably ionic or ionizable groups, such as COOH, SO₃H, NH₂, ammonium, phosphate, sulfate, imine, hydrazino, OH, SH groups or salts thereof. Such functional groups make it easier to prepare an AS coating aqueous composition by making conductive polymers more compatible with water and thus more soluble in the composition, what may improve the quality of the deposit.

Generally, the antistatic coating composition comprises water, preferably deionized water, or a water-miscible mixture of water and solvent as a solvent. Water-miscible solvents to be suitably used include the following alcohols: methanol, ethanol, n-propanol, isopropanol, n-butanol, isobutanol, sec-butanol, tert-butanol, n-amyl alcohol, isoamyl alcohol, sec-amyl alcohol, tert-amyl alcohol, 1-ethyl-1-propanol, 2-methyl-1-butanol, 1-methoxy-2-propanol, n-hexanol, cyclohexanol, ethyl cellosolve (monoethoxy ethyleneglycol), ethyleneglycol. It is also possible to add to said composition some amount of another hydrophilic organic solvent to facilitate the AS agent dissolution, or to improve the compatibility of the optional binder with the composition. To these purposes, organic solvents may be used, such as N-methylpyrrolidin-2-one (NMP), acetone, triethyl amine or dimethyl formamide (DMF).

Preferred conductive polymers are soluble or dispersible in water, in an alcohol or in a mixture of water and alcohol, so as to be applied onto a substrate in the form of a composition.

Suitable examples of commercially available antistatic coating compositions of the conductive polymer dispersion type include Baytron® P, based on a polythiophene, developed by the Bayer company and marketed by the H. C. Starck company. This is an aqueous dispersion of the poly(3,4-ethylenedioxythiophene)-poly(styrene sulfonate) polymer complex, noted PEDT/PSS, which comprises 1.3% by weight of conductive polymer-PSS. Such a composition leads to the production of an antistatic film with a very high heat resistance.

The antistatic coating composition will preferably comprise at least one binder. The binder may be any material that may be suitably used to form a film. It is defined as being a compound which does improve adhesion of the AS coating to the underlying layer and/or to the upper layer, and/or the antistatic coating integrity. The presence of a binder may enable, depending on the nature thereof, to reinforce the abrasion-resistant and/or scratch-resistant properties of the final optical article.

The binder should be compatible with the AS agent, that is to say should not be harmful to its antistatic properties, should form a stable solution which prevents said agent from aggregating to form more or less large particles or from precipitating, what would result in optical defects.

The selection of the binder generally relies on the solvent system used in the coating composition, because it should be soluble or dispersible in said solvent system.

The binder is preferably a polymer material, generally an organic polymer material. It may be formed from a thermoplastic or thermosetting material that may be optionally crosslinked by a condensation polymerization, an addition polymerization or a hydrolysis. Mixtures of binders belonging to various classes may also be used.

Binders are preferably soluble or dispersible in water or in an aqueous composition such as a water-alcohol composition. Suitable water-soluble or water-dispersible binders include homopolymers or copolymers from the following monomers: styrene, vinylidene chloride, vinyl chloride, alkyl acrylates, alkyl methacrylates, (meth)acrylamides, homopolymers or copolymers of the polyester, poly(urethane-acrylate), poly(ester-urethane), polyether, polyvinyl acetate, polyepoxide, polybutadiene, polyacrylonitrile, polyamide, melamine, polyurethane, polyvinyl alcohol type, their copolymers, and mixtures thereof. Poly(meth)acrylate-type binders include methyl polymethacrylate.

The binder may be a water-soluble polymer, or may be used in the form of a latex (polymer aqueous dispersion), for example a polyurethane latex such as Bayhydrol® 121 or Bayhydrol® 140AQ marketed by the H. C. Starck company, and optionally may be of the core-shell latex type. It may comprise hydrophilic functional groups such as sulfonic or carboxylic acid groups. As examples thereof may be mentioned sulfonated polyesters, such as the aqueous composition Eastek® 12100-02-30% marketed by the Eastman Chemical Company, and sulfonated polyurethanes.

Another class of binders to be suitably used in the antistatic coating composition comprises functionalized binders based on silane, siloxane or silicate (alkaline metal salt of a Si—OH compound), or hydrolyzates thereof. They are generally substituted with one or more organic functional group(s) and do form silica organosols. As binders, they generally do also function as adhesion-promoting agents towards an organic or a mineral glass substrate. These binders may also function as crosslinking agents for conductive polymers used in the form of polystyrene sulfonate salts.

Suitable examples of silicon-containing binders include silanes or siloxanes bearing an amine group such as amino alkoxysilanes, hydroxy silanes, alkoxysilanes, preferably methoxy or ethoxy silanes, for example epoxy alkoxysilanes, ureidoalkyl alkoxysilanes, dialkyl dialkoxysilanes (for example dimethyl diethoxysilane), vinylsilanes, allylsilanes, (meth)acrylic silanes, carboxylic silanes, polyvinyl alcohols bearing silane groups, tetraethoxysilane, and mixtures thereof.

After hydrolysis, the aforementioned organofunctional binders do generate interpenetrating networks by forming silanol groups, which are able to create bonds with the upper layer and/or the underlying layer.

The amino alkoxysilane binders may be chosen, without limitation, from the following compounds: 3-aminopropyl triethoxysilane, 3-aminopropylmethyl dimethoxysilane, 3-(2-aminoethyl)-3-aminopropyl trimethoxysilane, aminoethyl triethoxysilane, 3-(2-aminoethyl)aminopropylmethyl dimethoxysilane, 3-(2-aminoethyl)-3-aminopropyl triethoxysilane, 3-aminopropylmethyl diethoxysilane, 3-aminopropyl trimethoxysilane, and combinations thereof.

The ureidoalkyl alkoxysilane binders may be chosen, without limitation, from the following compounds: ureidomethyl trimethoxysilane, ureidoethyl trimethoxysilane, ureidopropyl trimethoxysilane, ureidomethyl triethoxysilane, ureidoethyl triethoxysilane, ureidopropyl triethoxysilane, and combinations thereof.

The binder is preferably an epoxy alkoxysilane, more preferably an alkoxysilane bearing a glycidyl group, and even more preferably a trialkoxysilane bearing a glycidyl group. These compounds include glycidoxymethyl trimethoxysilane, glycidoxymethyl triethoxysilane, glycidoxymethyl tripropoxysilane, α-glycidoxyethyl trimethoxysilane, α-glycidoxyethyl triethoxysilane, β-glycidoxyethyl trimethoxysilane, β-glycidoxyethyl triethoxysilane, β-glycidoxyethyl tripropoxysilane, α-glycidoxypropyl trimethoxysilane, α-glycidoxypropyl triethoxysilane, α-glycidoxypropyl tripropoxysilane, β-glycidoxypropyl trimethoxysilane, β-glycidoxypropyl triethoxysilane, β-glycidoxypropyl tripropoxysilane, γ-glycidoxypropyl trimethoxysilane, γ-glycidoxypropyl triethoxysilane, γ-glycidoxypropyl tripropoxysilane, hydrolyzates thereof, and mixtures thereof. γ-glycidoxypropyl trimethoxysilane (GLYMO), which is marketed in particular by the Merck company, is a particularly well suited binder in the context of the invention.

Other examples of alkoxysilanes to be suitably used bearing a glycidyl group include γ-glycidoxypropyl pentamethyl disiloxane, γ-glycidoxypropyl methyl diisopropenoxy silane, γ-glycidoxypropyl methyl diethoxysilane, γ-glycidoxypropyl dimethyl ethoxysilane, -glycidoxypropyl diisopropyl ethoxysilane, γ-glycidoxypropyl bis(trimethylsiloxy)methylsilane, and mixtures thereof.

The hereabove mentioned examples of binders only provide an overview of the binders for use in the context of the invention, and which should not in any case be considered as being limited to this list. The man skilled in the art will easily recognize other classes of compounds to be suitably used as binders for the antistatic coating composition.

Some antistatic coating compositions comprising a binder and a conductive polymer are commercially available and may be used in the context of the invention, as for example the D 1012 W composition (polyaniline aqueous dispersion), marketed by Ormecon Chemie GmbH, or the following compositions based on the Baytron® P dispersion, all being marketed by the H. C. Starck company: CPUD-2 (polyurethane binder), CPP 105D (GLYMO binder), CPP 103D (polyester-polyurethane aliphatic binder), CPP 116.6D and CPP 134.18D (polyurethane+GLYMO binder). The preferred coating composition is the CPP 105D composition, the solid content of which accounts for about 1.5% by weight. It provides AS coatings having a good adhesion to organic or mineral glass substrates.

In a particular embodiment of the invention, the antistatic coating composition does not comprise any binder.

When the AS coating composition comprises a binder, it may be crosslinked or cured thanks to the presence of at least one crosslinking agent which is preferably water-soluble or water-dispersible. These crosslinking agents are well known and do react with some functional groups of the binder, such as carboxyl or hydroxyl groups. They may be chosen from polyfunctional aziridines, methoxyalkylated melamine or urea resins, for example methoxymethylated melamine/formaldehyde resins and urea/formaldehyde resins, epoxy resins, carbodiimides, polyisocyanates, triazines and blocked polyisocyanates. The preferred crosslinking agents are aziridines, in particular trifunctional aziridines.

Particularly recommended polyfunctional aziridines are marketed under the trade name Neocryl CX-100® by the ZENECA RESINS company, XAMA-7® (pentaerythritol-tris-(β-(N-aziridinyl)propionate)) and XAMA-2® (trimethylolpropane-tris-(β-(N-aziridinyl)propionate)) by the B. F. Goodrich Chemical Company.

A crosslinking agent of the water-dispersible polyisocyanate type is marketed by the UNION CARBIDE company under the trade name XL-29 SE®. A crosslinking agent of the water-dispersible carbodiimide type is marketed by the BAYER company under the trade name XP 7063®, and a crosslinking agent of the methoxymethylmelamine type is marketed by the CYTEC company under the trade name CYMES® 303.

The antistatic coating composition may comprise additives traditionally used in this type of composition, such as antioxidants, stabilizers, doping agents such as organic acids, ionic or non ionic surfactants, adhesion-promoting agents or pH-regulating agents (in particular in the case of AS agents such as polypyrroles or polyanilines). They should neither reduce the AS agent efficiency nor affect the optical properties of the article.

Suitable examples of pH-regulating agents include acetic acid or an aqueous solution of N,N-dimethylethanolamine.

The antistatic coating composition of the invention generally has a solid content (solid compounds after solvent evaporation) whose weight represents less than 50% of the composition total weight, and represents preferably from 0.1 to 30% of the composition total weight, more preferably from 0.2 to 30%, and even more preferably from 0.2 to 15%, what includes both the required compounds (antistatic agents) and the optional compounds.

Once the antistatic coating composition has been applied onto the substrate, no migration or penetration of the conductive polymer into the substrate could be observed. The composition may then be dried or cured if necessary by any suitable means, for example by air-drying, in an oven or using a dryer, to provide a transparent conductive film. Generally, a temperature ranging from 50 to 200° C. is used. For organic substrates, a temperature lower than or equal to 120° C. is used. A high temperature and/or an extended drying/curing time sometimes enable to improve adhesion of the AS coating to the substrate. The curing/drying step comprises the solvent evaporation and the solidification of the optional binder. In the case of crosslinkable binders, the applied composition is submitted to a suitable energy source so as to initiate the binder polymerization and curing.

Once obtained the antistatic coating comprising at least one conductive polymer and optionally at least one cured binder, the deposition of the adhesive and/or impact-resistant primer coating onto the AS coating may be performed.

In a particular embodiment, the AS coating composition layer does not undergo any intermediate UV or heat curing prior to depositing the primer layer. Its curing (or drying) may be done concomitantly with that of the primer layer.

It should be noted that an antistatic coating of the conductive polymer type may also be formed by a gas phase (co)polymerization of monomer precursors, for example thiophene, furane, pyrrole, selenophene and/or a derivative thereof, in particular 3,4-ethylenedioxythiophene, such as described in the European patent application No 1 521 103. In this method, an oxidizing agent (catalyst) layer is first deposited onto the substrate, and thereafter brought into contact with the monomer precursor of the conductive polymer in a vaporized form.

As an alternative to obtain an antistatic coating of the conductive polymer type, a coating composition may be used, which comprises monomer precursors and an oxidizing agent, for example a Fe(III) salt, the formation of the conductive polymer being directly conducted onto the substrate. Said composition may optionally comprise a binder and additives such as previously described.

Several antistatic layers of the invention may be successively deposited onto the optical article surface. When these layers are wet deposited, it is preferred to carry out a single drying step for the whole antistatic stack.

The thickness of the AS coating of the invention in the final optical article does preferably range from 5 to 750 nm, more preferably from 10 to 500 nm, even more preferably from 20 to 500 nm and most preferably from 50 to 200 nm. Such thickness ranges do ensure the transparency of the coating. Moreover, limiting the thickness of the AS coating makes it possible in certain instances to improve the primer adhesion.

If the thickness of the AS coating becomes excessive, the visible light transmittance of the optical article may drop substantially, since most conductive polymers do absorb in the visible. The PEDT/PSS polymer for example does absorb high wavelengths in the visible range (near infrared). An excessively thick film of such a polymer will thus have a bluish color. On the contrary, if the thickness of the AS coating is insufficient, it has no antistatic properties.

Preferably, the optical article of the invention comprises on at least one main surface thereof a primer coating that improves the impact resistance (impact-resistant primer), deposited onto the antistatic coating. Such a primer coating also enables to improve adhesion of the subsequent layers. This may be any impact-resistant primer layer traditionally used for articles made of a transparent polymer material, such as ophthalmic lenses.

Preferred primer compositions allowing to produce the primer coating include thermoplastic polyurethane-based compositions, such as those described in the Japanese patents No 63-141001 and 63-87223, poly(meth)acrylic primer compositions, such as those described in the U.S. Pat. No. 5,015,523, thermosetting polyurethane-based compositions, such as those described in the European patent No 0 404 111 and poly(meth)acrylic latex-based compositions or polyurethane latex-based compositions, such as those described in the U.S. Pat. No. 5,316,791 and in the European patent No 0 680 492, as well as mixtures thereof.

As is well known, latexes are particulate stable dispersions of at least one polymer in an aqueous medium. Latexes used preferably comprise from 30 to 70% by weight of solid content.

Poly(meth)acrylic latexes are generally latexes of copolymers mainly based on a (meth)acrylate, such as for example ethyl, butyl, methoxyethyl or ethoxyethyl(meth)acrylate with a generally minor proportion of at least one other comonomer, such as styrene for example.

Preferred poly(meth)acrylic latexes are latexes of acrylate-styrene copolymers. Such latexes of acrylate-styrene copolymers are commercially available from the ZENECA RESINS company under the trade name NEOCRYL®, as for example the acrylate-styrene latex NEOCRYL® A-639, or from the B. F. Goodrich Chemical Company under the trade name CARBOSET®, as for example the acrylate-styrene latex CARBOSET® CR-714.

Polyurethane (PU) latexes are also known and commercially available. Preferred polyurethane latexes are polyurethane latexes comprising polyester units, preferably aliphatic polyester units. Preferably, polyurethanes are polyurethanes obtained by polymerizing at least one aliphatic polyisocyanate with at least one aliphatic polyol. These latexes enable to produce primers based on polyurethanes comprising polyester units.

Such polyester unit-containing PU latexes are marketed by the ZENECA RESINS company under the trade name Neorez® and by the BAXENDEN CHEMICALS company (a subsidiary of WITCO Corporation) under the trade name Witcobond®.

Commercially available primer compositions to be suitably used in the invention include Witcobond® 232, Witcobond® 234, Witcobond® 240, Witcobond® 242, Neorez® R-962, Neorez® R-972, Neorez® R-986 and Neorez® R-9603 compositions.

Preferred primer compositions are those compositions comprising at least one polyurethane, in particular compositions comprising at least one polyurethane latex. A primer composition may be used, which comprises several polyurethane latexes, or one or more polyurethane latex(es) combined with one or more other latex(es), in particular poly(meth)acrylic latexes. When present, the poly(meth)acrylic latex or the mixture of poly(meth)acrylic latexes generally represents from 10 to 90%, preferably from 10 to 60% and more preferably from 40 to 60% of the latex total weight in the primer composition. In the present document, unless otherwise indicated, latex weight percentages do correspond to the percentages of latex solutions comprised in the compositions, including the water and optional solvent weights of these solutions.

The impact-resistant primer coating of the invention preferably has a Young's modulus E′ measured at 2% elongation of less than 340 MPa, preferably of less than 300 MPa, and even more preferably of less than 250 MPa.

The Young's modulus E′ (or elastic energy storage modulus or modulus of longitudinal elasticity) may be measured by means of a Rheometrics Solid Analyser RSAII operating in tensile mode, in accordance with the procedure described in the standard ASTM D882. A low amplitude, sinusoidal dynamic strain, so as to remain in the linear elastic domain of the material, is applied to the specimen. The Young's modulus does correspond to the slope of the curve for the tensile stress plotted versus strain (at 2% elongation). It enables to evaluate the ability of the material to deform under the effect of an applied force.

The preferred primer composition is the Witcobond® 234, which makes it possible to produce a flexible impact-resistant primer.

The primer composition may optionally comprise a crosslinking agent in order to cure it. These crosslinking agents are well known and do react with functional groups of the resin present in the composition, such as carboxyl or hydroxyl groups, and may be chosen from the crosslinking agents that were previously described for the antistatic coating.

The amount of crosslinking agent in the primer compositions of the invention does generally range from 0 to 25% by weight as compared to the composition total weight, preferably from 0 to 5%, and more preferably is of about 3%. The crosslinking agent is added to the already prepared primer composition.

The primer compositions of the invention may comprise any component traditionally used in the primer layers for ophthalmic lenses, in particular an antioxidizing agent, an UV absorber, a surfactant, in the amounts traditionally used.

These primer compositions may be deposited on the article faces by dip-coating or spin-coating, and thereafter may be dried (cured) at a temperature of at least 70° C. and up to 100° C., preferably of about 90° C., for a time period ranging from 2 minutes to 2 hours, generally of about 15 minutes, so as to form primer layers with thicknesses after curing ranging from 0.2 to 2.5 μm, preferably from 0.5 to 1.5 μm.

Prior to depositing the adhesive and/or impact-resistant primer coating, the substrate coated with the AS coating may optionally have undergone a surface preparation step such as hereabove described for preparing the surface of the substrate prior to depositing the AS coating.

According to the invention, an abrasion-resistant and/or scratch-resistant coating is deposited onto the adhesive and/or impact-resistant primer coating. The abrasion-resistant and/or scratch-resistant coating may be any layer traditionally used as an abrasion-resistant and/or scratch-resistant coating in the optics field and in particular for ophthalmic lenses.

The abrasion-resistant and/or scratch-resistant coatings are preferably hard coatings based on poly(meth)acrylates or silanes.

The abrasion-resistant and/or scratch-resistant hard coatings are preferably produced from compositions comprising at least one alkoxysilane and/or a hydrolyzate thereof.

Recommended abrasion-resistant and/or scratch-resistant coatings herein include coatings obtained from a composition comprising an epoxysilane hydrolyzate such as those described in the patents FR 2 702 486 (EP 0 614 957), U.S. Pat. No. 4,211,823 and U.S. Pat. No. 5,015,523.

Preferred epoxysilanes are epoxy alkoxysilanes comprising preferably an epoxy group and three alkoxy groups, the latter being directly bound to the silicon atom. A preferred epoxy trialkoxysilane may be an alkoxysilane bearing a 3,4-epoxycyclohexyl group, such as 2-(3,4-epoxycyclohexyl)ethyl trimethoxysilane.

Particularly preferred epoxy alkoxysilanes have the formula (I):

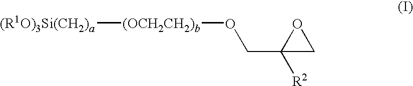

wherein R¹ is an alkyl group having from 1 to 6 carbon atoms, preferably a methyl or an ethyl group, R² is a methyl group or a hydrogen atom, a is an integer ranging from 1 to 6, and b is 0, 1 or 2. Examples of such epoxysilanes include γ-glycidoxypropyl triethoxysilane or γ-glycidoxypropyl trimethoxysilane. γ-glycidoxypropyl trimethoxysilane is preferably used.

Epoxy dialkoxysilanes may also be used as epoxysilanes, such as γ-glycidoxypropylmethyl dimethoxysilane, γ-glycidoxypropylmethyl diethoxysilane and γ-glycidoxyethoxypropylmethyl dimethoxysilane. These epoxy dialkoxysilanes may be used in combination with epoxy trialkoxysilanes, but in that case they will preferably be used in lower amounts than said epoxy trialkoxysilanes.

Other preferred alkoxysilanes have the following formula (II):

R³_{c}R⁴_{d}SiZ_{4-c-d} (II)

wherein R³ and R⁴ are selected from substituted or non substituted alkyl, methacryloxyalkyl, alkenyl and aryl groups (examples of substituted alkyl groups are halogenated alkyl groups, in particular of the chlorine or fluorine type), Z is an alkoxy, alkoxyalkoxy or acyloxy group, c and d are independently from each other 0, 1 or 2, and c+d represents 0, 1 or 2. This formula includes the following compounds: (1) tetraalkoxysilanes, such as methyl silicate, ethyl silicate, n-propyl silicate, isopropyl silicate, n-butyl silicate, sec-butyl silicate and t-butyl silicate, and/or (2) trialkoxysilanes, trialkoxyalkoxysilanes or triacyloxysilanes, such as the following compounds: methyl trimethoxysilane, methyl triethoxysilane, vinyl trimethoxysilane, vinyl triethoxysilane, vinyl trimethoxyethoxysilane, vinyl triacetoxysilane, phenyl trimethoxysilane, phenyl triethoxysilane, γ-chloropropyl trimethoxysilane, γ-trifluoropropyl trimethoxysilane, methacryloxypropyl trimethoxysilane, and/or (3) dialkoxysilanes, such as dimethyl dimethoxysilane, γ-chloropropylmethyl trimethoxysilane and methylphenyl dimethoxysilane.

Alkoxysilanes and/or acyloxysilanes hydrolyzates are prepared in a manner known per se. The methods proposed in the patents FR 2 702 486 and U.S. Pat. No. 4,211,823 may be used in particular.

Silane hydrolyzates may be prepared by adding to the silane precursors water or a hydrochloric acid or sulfuric acid solution. The hydrolysis may also be performed without adding any solvent, by simply using the alcohol or the carboxylic acid formed upon the reaction between water and the alkoxysilanes or acyloxysilanes. Other solvents may also be used instead of these solvents, such as alcohols, ketones, alkyl chlorides or aromatic solvents. Hydrolysis with a hydrochloric acid aqueous solution is preferred.

After the hydrolysis step, which will typically last from 2 hours to 24 hours, preferably from 2 hours to 6 hours, catalysts may be optionally added. A surfactant compound is preferably also added to the abrasion-resistant and/or scratch-resistant coating composition so as to improve the optical quality of the deposit.

A preferred abrasion-resistant and/or scratch-resistant coating composition is disclosed in the French patent No 2 702 486, in the name of the applicant. It comprises an epoxy trialkoxysilane and dialkyl dialkoxysilane hydrolyzate, colloidal silica and, in a catalytic amount, an aluminium-based curing catalyst such as aluminium acetylacetonate, the remainder being mainly represented by solvents that are traditionally used for formulating such compositions. The hydrolyzate used is preferably a γ-glycidoxypropyl trimethoxysilane (GLYMO) and dimethyl diethoxysilane (DMDES) hydrolyzate.

The abrasion-resistant and/or scratch-resistant coating composition may be deposited onto the AS coating by dip-coating or spin-coating. It is thereafter cured in a suitable way (preferably using a heat- or an UV-treatment).

The thickness of the abrasion-resistant and/or scratch-resistant coating does generally vary from 2 to 10 μm, preferably from 3 to 5 μm.

An antireflective coating may optionally, and preferably, be deposited onto the abrasion-resistant and/or scratch-resistant coating. An antireflective coating is defined herein as a coating, deposited onto the surface of an optical article, which does improve the antireflective properties of the final optical article. It enables reducing the light reflection at the article-air interface over a relatively large range of the visible spectrum.

Antireflective coatings are well known and traditionally comprise a monolayered or multilayered stack composed of dielectric materials such as SiO, SiO₂, Al₂O₃, MgF₂, LiF, Si₃N₄, TiO₂, ZrO₂, Nb₂O₅, Y₂O₃, HfO₂, Sc₂O₃, Ta₂O₅, Pr₂O₃, or mixtures thereof.

As is also well known, antireflective coatings are preferably multilayered coatings comprising alternately layers with a high refractive index (HI) and layers with a low refractive index (LI).

Antireflective coatings are generally applied by a vacuum deposition according to any of the following methods: i) by optionally ion-beam assisted, evaporation; ii) by ion-beam sputtering; iii) by cathode sputtering; iv) by plasma-assisted chemical vapor deposition.

In addition to vacuum deposition methods, an antireflective multilayered coating may be wet deposited, in particular by spin-coating liquid compositions comprising a silane hydrolyzate and colloidal materials with high or low refractive indices. Such a coating, whose layers comprise a silane-based organic/inorganic hybrid matrix, wherein colloidal materials are dispersed, enabling adjusting the refractive index of each layer, are described for example in the French patent No 2 858 420.

Advantageously, LI layers of the antireflective coating comprise a mixture of SiO₂ and Al₂O₃.

In the present application, a layer in an antireflective stack is said to be a high refractive index layer when the refractive index thereof is higher than 1.55, preferably higher than or equal to 1.6, more preferably higher than or equal to 1.8 and even more preferably higher than or equal to 2.0. A layer in an antireflective stack is said to be a low refractive index layer when the refractive index thereof is lower than or equal to 1.55, preferably lower than or equal to 1.50, more preferably lower than or equal to 1.45.

Unless otherwise indicated, the refractive indices which are referred to herein are determined at 25° C. at a wavelength of 550 nm.

Preferably, the total physical thickness of the antireflective coating is lower than 1 micrometer, more preferably lower than or equal to 500 nm and even more preferably lower than or equal to 250 nm. The total physical thickness of the antireflective coating is generally higher than 100 nm, preferably higher than 150 nm.

Instead of an antireflective coating, a mirror-type coating may be used, as for example in solar optics (such as sunglasses).

Mirror-type coatings are made of layers having the same nature as antireflective coatings. Their thickness is different and is adjusted so as to create a reflective effect.

Antireflective and/or mirror-type coatings may also have one or more layer(s) absorbing in the visible spectrum leading to optical articles to be suitably used for sunglasses.

A sublayer, generally made of SiO₂, may be inserted between the antireflective coating and the underlying coating, which is generally an abrasion-resistant and/or scratch-resistant coating, so as to improve the abrasion-resistant and/or scratch-resistant properties of the antireflective coating and to improve its adhesion to the underlying coating.

The optical article of the invention may also comprise coatings formed onto the antireflective coating and that are able to modify the surface properties thereof, such as hydrophobic and/or oleophobic coatings (antifouling top coat). These coatings are preferably deposited onto the outer layer of the antireflective coating. Their thickness is generally lower than or equal to 10 nm, preferably ranging from 1 to 10 nm, more preferably ranging from 1 to 5 nm.

There are typically coatings of the fluorosilane or fluorosilazane type. They may be obtained by depositing a fluorosilane or fluorosilazane precursor, comprising preferably at least two hydrolyzable groups per molecule. The fluorosilane precursors preferably comprise fluoropolyether groups and more preferably perfluoropolyether groups. These fluorosilanes are well known and are described, amongst others, in the U.S. Pat. Nos. 5,081,192, 5,763,061, 6,183,872, 5,739,639, 5,922,787, 6,337,235, 6,277,485 and in the European patent No 0 933 377.

Typically, an optical article according to the present invention comprises a substrate successively coated with an antistatic coating, with an adhesive and/or impact-resistant, preferably impact-resistant, primer coating, with an abrasion-resistant and/or scratch-resistant layer, with an antireflective coating and with a hydrophobic and/or oleophobic coating. The optical article may optionally be provided with other coatings, such as for example a polarizing coating, a photochromic coating, a tinted coating or another antistatic coating, such as for example an electroconductive layer that may be incorporated in an antireflective stack.

These other coatings may be deposited in a traditional manner such as by evaporation, by dipping or by spin-coating or be transferred from a laminated film.

The optical article coated according to the invention has a discharge time (i.e. a static charge dissipation time) ≦2 seconds, preferably ≦1 second, more preferably ≦500 milliseconds and even more preferably ≦200 milliseconds.

In the present application, the discharge time values for optical articles that have been beforehand submitted to a corona discharge were measured using a discharge time measuring device JCI 155 (John Chubb Instrumentation).

Preferably, the optical article of the invention does not absorb in the visible or does absorb little in the visible, what means herein that its visible light transmittance (Tv) is higher than 85%, more preferably higher than 90% and even more preferably higher than 92%. This characteristic may be obtained by selecting a limited antistatic coating thickness, what will be more clearly understood from the following experimental section.

Tv corresponds to the international standard definition (ISO13666 standard: 1998) and is measured according to ISO8980-3 standard. It is defined within the wavelength range from 380 to 780 nm.

Preferably, the light absorption of the optical article coated according to the invention is lower than or equal to 1%.

Preferably, the coating light absorption on the surface of the article is lower than 1%.

The present invention also relates to a method for making an optical article having antistatic properties such as hereabove described, comprising successively forming onto a substrate the antistatic coating, the adhesive and/or impact-resistant primer coating and the abrasion-resistant and/or scratch-resistant coating. Preferably, the antistatic coating is formed by depositing an antistatic coating composition such as hereabove illustrated.

Such a method is preferred as regards the implementation cost of the method and its productivity, compared to methods for making antistatic optical articles implying the deposition of an inorganic layer by evaporation, ion sputtering or plating, such as an indium tin oxide or noble metal layer.

The method of the present invention does not question the traditional methods for making ophthalmic lenses. It enables great production flexibility and may easily be integrated into a pre-existing production scheme. Indeed, this only requires adding to the machine to perform the deposition of the impact-resistant and abrasion-resistant coatings a vessel with an antistatic coating composition. The same machine may therefore be used for making both antistatic and non antistatic glasses.

Moreover, while the present invention does preferably apply to the production of optical articles, it may also apply to any article or substrate for which antistatic and abrasion/scratch-resistant properties and preferably impact-resistant properties are needed, as well.

The following examples are intended to illustrate the present invention in more detail but without limiting it thereto.

### EXAMPLES

### A—Testing Methods

a) Discharge Time

The optical article discharge times were measured at room temperature (25° C.) using a discharge time measuring device JCI 155 (John Chubb Instrumentation) according to the manufacturer's specifications, after said optical articles have been submitted to a −9000 volt corona discharge for 30 ms.

During these experiments for measuring the charge and the discharge of the surface of a glass submitted to a corona discharge, both following parameters were determined: the maximum voltage measured on the glass surface, noted Uₘₐₓ, and the time needed to reach 1/e=36.7% of the maximum voltage, noted t (1/e), which corresponds to the discharge time.

The power of the used glasses should be strictly the same so that the performances of the various glasses can be compared with each other, because the values measured by the device depend on the glass geometry.

b) Calibrated Dust Attraction Test

This test consists in charging the surface of a glass with static electricity of the triboelectricity type. To that aim, a glass is rubbed with a wiping cloth by conducting a circular motion (about twenty revolutions are conducted). The friction of the wiping cloth results in tearing electrons out of the glass surface or out of the wiping cloth surface, depending on the nature of the materials. Depending on the nature of the wiping cloth used, the surface of the glass becomes more or less charged. The thus charged glass is moved near to a 75 mm diameter cylindrical can having deposited thereon a uniform layer of calibrated dust (1-200 μm, distance glass to layer of dust: approx. 15 mm).

When the glass is antistatic, it becomes very little charged, does dissipate very quickly the charges which were created on its surface and does not attract dust or very little.

When the glass is not antistatic, it does attract a great amount of dust. The charge that is created on its surface hardly dissipates, so that its surface remains highly charged and generates an electric field which does polarize and attract dust. The attracted dust amount directly depends on the intensity of the created electric field, which in turn depends on the number of charges created on the glass surface. The attracted dust amount is visually quantified.

This test is above all useful to identify glasses having extreme behaviours regarding triboelectricity, that is to say glasses that are “highly antistatic” or “not antistatic at all”.

c) Adhesion Test by Dipping in Boiling Hot Water

This test enables to determine the stability and the adhesion of a coating to a substrate or to another coating.

The adhesion test, which is performed in accordance with the NF T 30-038 standard, results in the production of a 0 to 5 classification. It consists in dipping the optical article coated with one or more coating(s) in a boiling hot water bath for one hour, thereafter in scoring the coating by means of a cutter, according to a cross-hatch pattern of cutting lines, in applying an adhesive tape to the thus cross-hatched coating and in trying to tear it out by means of the same.

The results are considered as being good when noted zero, i.e. when the cutting edges remain perfectly smooth and when no cross-hatch element defined thereby has been removed.

d) Suntest The lenses do undergo a radiation in a Suntest device such as a CPS+ device (from the Heraeus company).

This device does use a Xenon 60 Klux, 1.5 KW lamp. The lenses are irradiated for 200 hours.

e) Abrasion Resistance Test (BAYER ISTM)

This test consists in simultaneously stirring a sample glass and a specimen glass with a determined reciprocating movement in a vessel filled with an abrasive powder having a defined particle size at a frequency of 100 cycles/minute for 2 minutes. The haze value H “before/after” for the sample glass is compared to that of a specimen glass, that is to say a CR-39®-based bare glass, the BAYER value of which is set to 1. The BAYER value is R=specimen H/sample glass H.

Determining the ISTM BAYER value was performed according to the F735-81 ASTM standard, with the following changes:

Abrasion is performed over 300 cycles using around 500 g of ZF 152412 alumina (aluminium oxide Al₂O₃) provided by the Ceramic Grains company (formerly Norton Materials, New Bond Street, PO Box 15137 Worcester, Mass. 01615-00137). The haze value is measured using a Hazemeter apparatus, model XL-211.

The higher the BAYER test value, the stronger the abrasion resistance.

The ISTM Bayer value is considered to be satisfying when R is greater than or equal to 3 and is lower than 4.5, and considered as being excellent for values of 4.5 and above.

f) Impact Resistance Test.

The impact resistance for the obtained optical articles (ophthalmic lenses) is determined according to the falling ball test.

In this test, balls are dropped with an increasing energy in the middle of the glass until a break (generally a star-shaped break) or a fracture of the lens occurs.

The minimum energy set during this test is 15.2 g/m (corresponding to the initial drop height). This energy accounts for 200 mJoules and corresponds to the minimum value specified by the FDA.

### B—Operating Procedures and Results

1—ORMA®Substrate

1.1—General Procedures

Optical articles used in Examples 1-3 and C1, C2 comprise an ESSILOR ORMA® lens substrate (refractive index on the order of 1.50) with a 65 mm diameter, a −2.00 diopters power and a 1.2 mm thickness. Unless otherwise indicated, both faces thereof have been treated.

First of all, the substrates were submitted to a surface preparation step that is said to be a “basic/solvent” step in the context of this experiment section (soda, then soft water, deionized water and lastly isopropyl alcohol), prior to being coated with an antistatic coating of the invention, submitted to a surface preparation step using water, then deionized water without ultrasounds, and coated with an impact-resistant primer coating based on a polyurethane-type latex comprising polyester units, cured at 90° C. for 1 hour (Witcobond® 234 from BAXENDEN CHEMICALS modified by dilution to obtain the suitable viscosity, spin-coating at 1500 rpm for 10 to 15 seconds). Once cooled, the impact-resistant primer coating was coated with the abrasion-resistant and/or scratch-resistant coating (hard coat) disclosed in Example 3 of the European patent No 0 614 957 (refractive index=1.50), based on a hydrolyzate of GLYMO and DMDES, colloidal silica and aluminium acetylacetonate. Such an abrasion-resistant coating is obtained by dip-coating, then by curing (1 hour at 90° C.) a composition comprising, by weight, 224 parts of GLYMO, 80.5 parts of HCl 0.1 N, 120 parts of DMDES, 718 parts of a 30 wt % colloidal silica in methanol, 15 parts of aluminium acetylacetonate and 44 parts of ethylcellosolve. The composition further comprises 0.1% by weight of FLUORAD™ FC-430®, a surfactant from the 3M company, as compared to the composition total weight.

Lastly, a number of glasses were provided with a ZrO₂/SiO₂/ZrO₂/SiO₂ tetralayered antireflective coating, deposited onto the abrasion-resistant coating by evaporation under vacuum of the materials in the mentioned order (thickness of the layers: 27, 21, 80 and 81 nm, respectively).

The percentages indicated are weight percentages, unless otherwise specified.

1.2—Preparation of the Antistatic Coating: Experimental Details

The AS coating composition used is the CPP 105D composition based on Baytron® P marketed by the H. C. Starck company (poly(3,4-ethylenedioxythiophene)-poly(styrene sulphonate) aqueous dispersion with a solid content of 1.3% by weight), beforehand diluted with isopropyl alcohol so as to reach a solid content lower than or equal to 1% by weight.

The antistatic coating was formed on the glass surface by dipping substrates for 10 seconds in the CPP 105D composition diluted as hereabove described. Glasses were thereafter removed from the composition at a rate of 3.7 cm/min, placed in an oven for 5 min at 100° C. in order to dry the deposited layer. Under these deposition conditions, the thickness of the conductive polymer-based AS coating does vary from 50 to 150 nm, which enables obtaining transparent articles.

A number of thus prepared glasses were submitted to solvent resistance tests. It could be observed that the AS coating is not altered by deionized water, methanol, ethanol or isopropyl alcohol.

In addition, it could be observed that the AS coating had a very good adherence to the ORMA® substrate.

1.3—Optical Article Test Results

Optical articles comprising a stack composed of ORMA®/AS coating/impact-resistant primer/abrasion-resistant and/or scratch-resistant coating and optionally an antireflective coating (AR) were submitted to various assays to evaluate their antistatic properties, whose results are listed in Table 1.

Comparative assays were also performed on optical articles similar to those of Examples 1 and 2 except that they had no AS coating.

TABLE 1

| Example | AR coating | Uₘₐₓ (V) | t (1/e) (ms) | Tv (%) |
|---|---|---|---|---|
| 1 | yes | −75.2 | 61 | |
| | | −79.1 | 59 | |
| | | −77.9 | 55 | |
| | | −82.8 | 41 | |
| | | −120 | 100 | |
| | | −88 | 39 | |
| | | −85 | 47 | |
| | | −75 | 61 | |
| 2 | no | −92 | 37 | 91.3 |
| | | −71 | 43 | |
| Comparative 1 (C1) | yes | −643 | 23 900 | |
| | | −667 | 23 500 | |
| Comparative 2 (C2) | no | −675 | 92 700 | 92.7 |
| | | −682 | 90 400 | |

The presence of the AS coating makes it possible to divide by approx. 1000 the discharge time and by approx. 10 the maximum voltage measured on the glass surface (Uₘₐₓ). The presence of an antireflective coating does not alter the antistatic properties of an article comprising a conductive polymer layer.

The same assays performed on glasses of the invention four months after their preparation revealed that their antistatic properties were unchanged.

Moreover, it has been controlled that the glasses of Examples 1 and 2 did not attract dust during the calibrated dust attraction test, as opposed to the glasses of Comparative Examples 1 and 2.

The transmittance values measured do reveal that the antistatic coating of the invention (example 2) has a sufficiently low thickness so as not to significantly affect the light transmission.

FIG. 1 illustrates the visible light transmittance curve for a bare ORMA® substrate, for the glass of Example 2 (prior to depositing the primer coating and the abrasion-resistant coating) and for the glass of Example 3 (prior to depositing the primer coating and the abrasion-resistant coating) which is identical to the one of Example 2 except that the antistatic coating has a substantially higher thickness (450-600 nm). This diagram shows that an excessively high thickness of the antistatic coating results in a transmittance loss.

In addition, it could be observed that the primer coating has a very good adhesion to the antistatic coating since it does pass the adhesion test in boiling hot water. The abrasion-resistant coating does also pass the adhesion test in boiling hot water.

A few assays were also carried out on solar tinted (brown 3) flat ORMA® glasses, power 0.00 diopter (obtained by dipping in a coloring bath). It could be observed that these glasses, once coated with an AS, an impact-resistant and an abrasion-resistant coating have the same properties as non tinted ORMA® glasses. No decolorizing or conductive polymer loss could be observed upon dipping the glasses in the impact-resistant primer coating and abrasion-resistant coating composition baths. However, the presence of the antistatic coating slightly modifies its transmission spectrum (CIE color model values L, a*, b*).

Lastly, glasses of Examples 1 and 2 were submitted to the suntest (200 hours) as previously described.

After that test, glasses are noted 0 for the adhesion test by dipping in boiling hot water (very good adhesion) and have the same antistatic properties as before the suntest.

2—Polycarbonate Substrate (Bisphenol-A Polycarbonate) (PC)

2.1—General Procedures

Optical articles were obtained using the same protocol as for the ORMA® substrate but with a different substrate surface preparation step prior to depositing the antistatic coating.

Two surface preparation methods do enable solving this problem.

The first solution consists in submitting the PC substrate to a basic/solvent surface preparation step as previously described (which enables both removing the varnish from the substrate and cleaning the surface thereof), then submitting the same to an ultraviolet treatment (device from Fusion UV Systems, Inc., Model F300S, bulb H, for 15 to 35 seconds, at a glass-UV lamp distance of 90 mm).

The second solution consists in submitting the PC substrate to a basic/solvent surface preparation step as previously described, then in coating the same with a layer of an aminosilane-type adhesion-promoting agent, A1100 (by dipping).

After one of these two treatments, the AS coating does pass the adhesion test in boiling hot water.

Substrates with a 0.00 diopter power were used.

2.2—Optical Article Test Results

An optical article comprising a stack composed of PC substrate/AS coating/impact-resistant primer/abrasion-resistant and/or scratch-resistant coating, prepared according to the protocol of the previous subsection, was submitted to various tests for evaluating its antistatic properties (example 4), whose results are listed in Table 2.

A comparative test was conducted on the same optical article as the one of Example 4 except that it had no AS coating.

TABLE 2

| | Antistatic coating deposition | Uₘₐₓ | t (1/e) | Tv |
|---|---|---|---|---|
| Example | method | (V) | (ms) | (%) |
| 4 (PC substrate) | Dip-coating (*) | −72 | 63 | |
| | | −90 | 27 | |
| Comparative 3 (C3, PC substrate) | — | −563 | >500000 | |
| | | −585 | >500000 | |
| 5 (MR7 substrate) | Dip-coating (*) | −134 | 74 | |
| | | −74 | 80 | |
| | Spin-coating (**) | −240 | 150 | |
| | Spin-coating (***) | −73 | 96 | 90.2 |
| Comparative 4 (C4, MR7 | — | −1090 | 35100 | |
| substrate) | | −1030 | 32200 | |
| 6 (MR8 substrate) | Dip-coating (*) | −54 | 92 | |
| | | −41 | 127 | |
| | Spin-coating (**) | −63 | 56 | |
| | Spin-coating (***) | −65 | 102 | 90.9 |
| Comparative 5 (C5, MR8 | — | −977 | 41200 | |
| substrate) | | −971 | 37300 | |

(*) Rate: 3.7 cm/s.
(**): Rate: 1000 rpm, a single face was treated.
(***): Rate: 1500 rpm, a single face was treated.

The optical article of Example 4 has AS properties that are similar to those of the articles of Examples 1 and 2.

Moreover, it could be observed that the primer coating has a very good adhesion to the antistatic coating since it did pass the adhesion test in boiling hot water. The abrasion-resistant coating also did pass the adhesion test in boiling hot water.

3—Other Substrates

Optical articles comprising a stack composed of −2.00 diopter-power substrate/AS coating/impact-resistant primer/abrasion-resistant and/or scratch-resistant coating, were submitted to various assays to evaluate their antistatic properties, whose results are listed in Table 2. They were obtained using the same protocol as for the ORMA® substrate.

The MR7 and MR8 substrates are organic glasses with a high refractive index (higher than 1.60). They are polythiourethane substrates for ophthalmic lenses (spectacle glasses), provided by the Mitsui company.

Comparative assays were also performed on optical articles similar to those of Examples 5 and 6 except that they had no AS coating.

Sometimes, the AS coating was deposited by spin-coating rather than by dip-coating, with little effect on the antistatic properties.

In each case, it could be observed after the adhesion test in boiling hot water that the primer coating had a very good adhesion to the antistatic coating. The abrasion-resistant coating did also pass the adhesion test in boiling hot water.

A number of glasses were submitted to solvent resistance tests (prior to depositing the impact-resistant primer coating and the abrasion-resistant coating). It could be observed that the AS coating was not altered by deionized water, methanol, ethanol or isopropyl alcohol.

Glasses treated according to the invention exhibit undeniable AS properties. This result is particularly interesting as regards the MR7 substrate, which, when lacking an AS coating, becomes very easily charged, even if it has not been rubbed beforehand. This ability for a MR7 glass to become easily charged was verified by means of the JCI device, since a −9000 volt-corona discharge for 30 ms charged it beyond −1000 V (example C4), the charge decreasing only very slowly over the time (a few % decrease only, ten minutes after the charge was applied).

The invention thus enables to make AS any type of glass, even those which do become charged very easily.

4-ORMA® Substrates—Abrasion- and Impact-Resistance Tests

4.1—General Procedures

Optical articles were obtained using the same protocol as for the ORMA® substrate as previously described in 1), except that:
Said optical articles are more precisely ophthalmic lenses with a power of −0.75 diopters and a central thickness of about 1.60 mm.
Thickness of the AS coating is 500 nm (the solid content is increased as compared to 1) so as to reach this thickness).

4.2—Test Results: Example 7 and Comparative Example 6

The abrasion resistance was measured by performing the “Bayer ISTM” test on the stacks: Orma® substrate/impact-resistant primer/abrasion-resistant and/or scratch-resistant coating (Comparative Example 6) and Orma® substrate/antistatic coating/impact-resistant primer/abrasion-resistant and/or scratch-resistant coating (Example 7).

Results are given in Table 3 hereunder.

TABLE 3

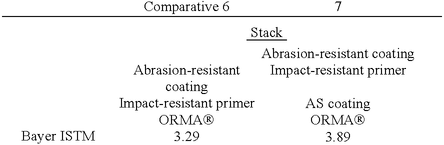

The stack with the antistatic coating has improved Bayer values as compared to the same stack without such a coating.

### Impact Resistance Test Results

The tests were each time performed on 50 ophthalmic lenses.

The energy-to-break indicated in the examples is the average energy-to-break.

In addition, all glasses, both in the examples of the invention and in the comparative examples did meet the FDA requirements, that is to say each of them has an energy-to-break higher than that required by the FDA and even twice higher than this threshold.

### Comparative Example 7

ORMA® substrate (central thickness 1.62 mm)/impact-resistant primer/abrasion-resistant and/or scratch-resistant coating.

Average energy-to-break: between 3.5 and 4 times the FDA threshold.

### Example 8

ORMA® substrate (central thickness 1.60 mm)/AS coating/impact-resistant primer/abrasion-resistant and/or scratch-resistant coating.

Average energy-to-break: between 3 and 3.5 times the FDA threshold.

### Comparative Example 8

ORMA® substrate (central thickness 1.62 mm)/impact-resistant primer/abrasion-resistant and/or scratch-resistant coating/antireflective coating.

Average energy-to-break: between 4.5 and 5 times the FDA threshold.

### Example 9

ORMA® substrate (central thickness 1.59 mm)/AS coating/impact-resistant primer/abrasion-resistant and/or scratch-resistant coating/antireflective coating.

Average energy-to-break: between 3.5 and 4 times the FDA threshold.

Despite the high thickness (500 nm) of the antistatic coating, only a slight decrease in the impact resistance could be observed.

All lenses have an average energy-to-break that is at least 3 times the minimum energy-to-break recommended by the FDA.

The antistatic performance was checked by means of the JCI device according to the previously mentioned protocol. All glasses provided with the antistatic coating actually have antistatic properties (discharge time of less than 200 ms).

1.-24. (canceled)

25. An optical article comprising a substrate, and from the substrate upward:
an organic antistatic coating comprising at least one conductive polymer;
an adhesive and/or impact-resistant primer coating deposited onto said antistatic coating; and
an abrasion-resistant and/or scratch-resistant coating deposited onto said adhesive and/or impact-resistant primer coating.

26. The article of claim 25, wherein the adhesive and/or impact-resistant primer coating is an impact-resistant primer coating.

27. The article of claim 26, wherein the impact-resistant primer coating is a polyurethane-based coating comprising polyester units.

28. The article of claim 26, wherein the impact-resistant primer coating has a Young's modulus E′ measured at 2% elongation of less than 340 MPa.

29. The article of claim 25, wherein the thickness of the antistatic coating is from 10 to 500 nm.

30. The article of claim 25, wherein the conductive polymer comprises a polyaniline, polypyrrole, polythiophene, polyethylene imine, polyselenophene, allylamine-based compound, and/or derivative of one of these polymers.

31. The article of claim 30, wherein the conductive polymer comprises a polystyrene sulfonate polypyrrole and/or polystyrene sulfonate polythiophene.

32. The article of claim 25, wherein the antistatic coating comprises at least one cured binder.

33. The article of claim 25, wherein the static charge dissipation time is ≦500 milliseconds.

34. The article of claim 25, wherein the abrasion-resistant and/or scratch-resistant coating is a poly(meth)acrylate- or silane-based coating.

35. The article of claim 25, wherein an antireflective coating is deposited onto the abrasion-resistant and/or scratch-resistant coating.

36. The article of claim 25, further defined as having a visible light transmittance (Tv) higher than 85%.

37. The article of claim 25, wherein the substrate is an organic or a mineral glass.

38. The article of claim 25, further defined as an optical lens.

39. A method for making the optical article of claim 25, comprising successively forming onto a substrate the antistatic coating, the adhesive and/or impact-resistant primer coating and the abrasion-resistant and/or scratch-resistant coating.

40. The method of claim 39, wherein the antistatic coating is formed by depositing an antistatic coating composition comprising at least one conductive polymer.

41. The method of claim 40, wherein the antistatic coating composition comprises at least one binder.

42. The method of claim 41, wherein the binder is a water-soluble or water-dispersible polymer material further defined as a binder based on silane, siloxane or silicate, or on homopolymer or copolymers of the following monomers: styrene, vinylidene chloride, vinyl chloride, alkyl acrylates, alkyl methacrylates, (meth)acrylamides, on homopolymer or copolymers of the polyester, poly(urethane-acrylate), poly(ester-urethane), polyether, polyvinyl acetate, polyepoxide, polybutadiene, polyacrylonitrile, polyamide, melamine, polyurethane, polyvinyl alcohol type, their copolymers, and mixtures thereof.

43. The method of claim 42, wherein the binder is an epoxy alkoxysilane.

44. The method of claim 40, wherein the antistatic coating composition comprises a dispersion or a solution of at least one conductive polymer in an aqueous or organic solvent, or in a mixture of these solvents.

45. The method of claim 39, wherein the surface of the substrate, prior to depositing the antistatic coating, is submitted to a chemical or physical activating preliminary treatment comprising a bombardment with energetic species, a corona discharge treatment, an electric discharge treatment in a low pressure gas, a plasma treatment under vacuum, an ultraviolet treatment, an acid treatment, a solvent-based treatment, the deposition of an adhesion-promoting agent layer, or a combination of these treatments.

46. The method of claim 45, wherein the surface of the substrate, prior to depositing the antistatic coating, is coated with a layer of an adhesion-promoting agent obtained from a composition comprising polymers or copolymers of the polyester, polyurethane, polyamide, polycarbonate type, or polymers or copolymers based on acrylate or methacrylate, butadiene, vinyl halide, maleic anhydride monomers, or at least one silane or siloxane, or mixtures thereof.

47. The method of claim 39, wherein the abrasion-resistant and/or scratch-resistant coating is obtained by depositing a composition comprising an epoxysilane hydrolyzate.

48. The method of claim 39, wherein the adhesive and/or impact-resistant primer coating is obtained by depositing a composition based on thermoplastic polyurethanes, a poly(meth)acrylic primer composition, a composition based on thermosetting polyurethanes, a composition based on poly(meth)acrylic latexes or on polyurethane-type latexes, or mixtures thereof.
